(19) United States
(12) Patent Application Publication
(10) Pub. No.: US 2009/0176090 A1
(43) Pub. Date: Jul. 9, 2009

(54) METHOD FOR EFFICIENT AL-C COVALENT BOND FORMATION BETWEEN ALUMINUM AND CARBON MATERIAL

(75) Inventors: Kang Pyo So, Namwon (KR); Young Hee Lee, Suwon (KR); Kay Hyeok An, Suwon (KR)

Correspondence Address: EDWARDS ANGELL PALMER & DODGE LLP, P.O. BOX 55874, BOSTON, MA, 02205, US

(73) Assignees: Sungkyunkwan University Foundation for Corporate Collaboration, Suwon (KR); Dayou Smart Aluminium Co., Ltd., Gwangju (KR)

(21) Appl. No.: 12/179,541

(22) Filed: Jul. 24, 2008

(30) Foreign Application Priority Data
Jan. 4, 2008 (KR) 10-2008-0001233

(51) Int. Cl. B32B 5/02; B01J 19/08; B01J 19/10; B32B 5/16; C25D 7/00; C25D 5/54; B01J 19/12; C01B 31/00

(52) U.S. Cl. 428/367; 204/164; 204/157.42; 204/157.43; 204/157.6; 423/439; 205/158; 205/50; 428/402

(57) ABSTRACT

Disclosed is a method of forming an Al—C covalent bond between aluminum and a carbon material by applying an electric arc to a mixture of the aluminum and the carbon material under vacuum, heated and pressurized conditions. In order to enhance the reactivity of the carbon material, the method may include the step of introducing defects in the carbon material and thus functionalizing the carbon material by treating the carbon material with acid, a microwave, or plasma.

### CROSS-REFERENCE TO RELATED APPLICATION

This application claims under 35 U.S.C. §119(a) the benefit of Korean Patent Application No. 10-2008-0001233 filed Jan. 4, 2008, the entire contents of which are incorporated herein by reference.

### BACKGROUND

1. Technical Field

The present invention relates to a method for Al—C covalent bond formation using an electric arc or an electrochemical technique.

2. Background Art

Aluminum is used in a broad range of applications, ranging from daily products, such as kitchen foil, disposable tableware, and the like, to durable goods, such as windows, vehicles, aircrafts, and so forth. Aluminum is characterized by light weight that is only a third of that of steel, and has superior strength through alloying with other metals. Also, aluminum is chemically stable because a chemically stable oxide layer existing on an aluminum surface prevents corrosion from being caused by moisture or oxygen.

On account of this, aluminum has been widely used in vehicles, aircrafts, etc. In particular, aluminum wheels employed in vehicles are lighter than conventional steel wheels, and thus can reduce their own loads, which contributes to improving in fuel efficiency, as well as decreasing the weight of a vehicle body. However, when aluminum is used for structural materials, such as structural tubes or sheets, structural aluminum materials must be thick because aluminum has tensile strength corresponding to only about 40% of that of steel, which lead to excessive consumption of materials and thus excessive cost of materials.

To solve this problem, research is being vigorously pursued to prepare aluminum/carbon material joints and composites. As an example, Korean Patent Laid-Open Publication No. 10-2003-0046378 discloses a method of producing joint materials suitable for structural materials by integrating carbon fibers and aluminum by use of additives. However, this method has a limitation on an interfacial bonding force between aluminum and a carbon material due to the use of additives, and is problematic in that adhesive strength is lowered because joint materials must be deformed for shaping thereof.

In addition to the method of preparing a complex by use of an intermediate material, active research on composite materials is underway. Among others, a method of producing composite materials of carbon fibers/carbon nanotubes and aluminum is largely divided into a method using plasma and a plating method.

The method using plasma is a method in which a carbon material is sintered by melting aluminum in a moment through high-energetic plasma. An example thereof is disclosed in Japanese Patent Laid-Open Publication No. 2006-315893 (2006.11.24). However, the method using plasma has a disadvantage in that the productivity is lowered since the apparatus is expensive and high frequency needs to be applied for a long time.

The electroplating means a method of preparing a composite material plating solution, applying a potential, and plating a composite material (Japanese Patent Laid-Open Publication No. 2007-070689). In this technology, a carbon nanotube and aluminum are dissolved in a plating solution so that the two materials can reach the surface of the cathode, thereby forming a complex. In this method, however, there is a disadvantage in that the binding force between aluminum and carbon material cannot be controlled and the yield decreases.

The formation of such an aluminum/carbon material composite is accompanied by several problems, which are essentially caused by differences in physical and chemical properties between these two substances. First, carbon materials, e.g., carbon nanotubes have high interactive cohesive force by Van der Waals force, and thus are difficult to uniformly disperse in aluminum matrix. Second, a carbon material and an aluminum matrix have different surface tensions. A good example showing great difference in surface tensions is water and oil, water being 2-3 times as great as oil. However, a recent research report revealed that surface tension of aluminum is 955 mN/m, and surface tension of a carbon material is 45.3 mN/m [based on J. M. Molina et al. International Journal of adhesion Adhesives 27 (2007) 394-401, S. Nuriel, L. Liu, A. H. Barber, H. D. Wagner. Direct measurement of multiwall nanotube surface tension, Chemical Physics Letters 404 (2005) 263-266]. That is, the difference in surface tensions between these two materials is about 20 times greater than the other. This result indicates that the two materials are hard to mix with each other. Also, since the density of the two materials are significantly different, they hardly mix with each other when they are melted.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Thereupon, the present invention has been made to solve at least the above-mentioned problems occurring in the prior art, and the present inventors has solved the existing problem of bonding between aluminum and a carbon material by using an electric arc or an electrochemical technique. The method of electric arc induces an Al—C covalent bond by generating electric arc or Joule heat within the compound of carbon nanotube and aluminum when the electrons flow between a carbon material and aluminum. The electrochemical technique allows carbon included in a carbon material to form an Al—C covalent bond by reacting with aluminum that is reduced by a potential difference.

It is the object of the present invention to provide a method of forming a covalent bond between aluminum and a carbon material by using an electric arc.

It is another object of the present invention to provide a method of fabricating an aluminum/carbon material composite in which a covalent bond is formed by applying an electric arc, and the aluminum/carbon material composite fabricated according to the above method.

It is yet another object of the present invention to provide a method of forming a covalent bond between aluminum and a carbon material by using an electrochemical technique.

It is still yet another object of the present invention to provide a method of fabricating an aluminum/carbon material composite in which a covalent bond is formed by using an electrochemical technique, and the aluminum/carbon material composite fabricated according to the above method.

In accordance with an aspect of the present invention, there is provided a method for covalent bond formation between aluminum and a carbon material, the method including the steps of: (i) introducing defects in a carbon material to thereby functionalize the carbon material; (ii) mixing the functionalized carbon material with aluminum to thereby obtain a mixture; and (iii) inducing an Al—C covalent bond by applying an electric arc to the mixture.

Preferably, at least one or two kinds of materials selected from the group consisting of graphite, a graphite fiber, a carbon fiber, a carbon nanofiber, and a carbon nanotube may be used as the carbon material.

It is known that a carbon material available at present has a diameter of 0.4 nm to 16 μm and a length of 10 nm to 10 cm. That is, according to the data reported so far (Science 292, 2462 (2001)), a carbon nanotube is known to have a minimum diameter of 0.4 nm, and a commercialized carbon fiber is known to have a maximum diameter of 16 μm (Taiwan Carbon Technology Co). In examples of the present invention, a multi-walled carbon nanotube with a diameter of 10 to 20 nm and a length of 10 to 20 μm, and an NK carbon nanotube with a diameter of 40 to 60 nm and a length of about 20 μm, were used as a carbon material respectively. A carbon fiber (Toray) with a diameter of 7 to 8 μm and a length of 5 mm was also used. However, in the method of the present invention, no limitation is imposed on the size of a carbon material.

In introducing defects in a carbon material to thereby functionalize the carbon material in step (i), the carbon material may be treated with acid. Acid used in such an acid treatment may include nitric acid (HNO₃), sulfuric acid (H₂SO₄), or a mixture of nitric acid and sulfuric acid. A carbon nanotube forms a sp²-hybridized bond, and has a cylindrical-shaped structure. However, such a structure of the carbon nanotube is difficult to bond with other substances due to its inert surface. Thus, in the composite, defects of carbon nanotube, such as a groove or functional group, is formed therein so that it can bond with a matrix. Also, functionalizing a carbon material refers to enhancing the reactivity of a carbon material by attaching a functional group with specific reactivity, such as —OH, —COOH, —CHO, etc., to the carbon material.

In introducing defects in a carbon material to thereby functionalize the carbon material in step (i), the carbon material may be treated with a microwave. A solvent is used in such a microwave treatment, and the solvent may include any one kind of material or a mixture of at least two kinds of materials selected from the group consisting of ethylene glycol, nitric acid (HNO₃), and sulfuric acid (H₂SO₄). The microwave treatment may be carried out for 1 to 10 minutes.

In introducing defects in a carbon material to thereby functionalize the carbon material in step (i), the carbon material may be treated with plasma. In such a plasma treatment, any one kind of gas or a mixture of at least two kinds of gases selected from the group consisting of oxygen, argon, and helium may be used. Also, an electric power of 50 to 1000 W and a treatment time of 1 minute to 1 hour may be used in the plasma treatment.

Although the acid, microwave, or plasma treatments are described as a way to introduce defects to thereby functionalize the carbon material in step (i), the method of the present invention is not limited thereto. The term “functionalize” as used herein means forming defects in a carbon material and attaching functional groups to the defects.

In mixing the functionalized carbon material with aluminum in step (ii), a ball mill treatment or an ultrasonic dispersion treatment in a liquid may be employed. Also, the carbon material may be mixed with aluminum in a mixing ratio of 0.1 to 50% by weight. In the ball mill treatment, aluminum and the carbon material, together with balls, are put into a steel vessel, and ball milling is conducted under an inert gas atmosphere to obtain mixed aluminum/carbon powder. In the ultrasonic dispersion treatment in a liquid, carbon material and aluminum particles are dispersed in ethanol or deionized water, and then the dispersed particles are subjected to drying and filtering.

In step (iii), arc discharge may be induced by applying a pulse current to the mixture of the carbon material and aluminum.

In accordance with another aspect of the present invention, there is provided a method of fabricating an aluminum-carbon material composite, the method comprising the steps of: (i) introducing defects in a carbon material to thereby functionalize the carbon material; (ii) mixing the functionalized carbon material with aluminum to thereby obtain a mixture; and (iii) inducing an Al—C covalent bond by applying an electric arc to the mixture. Additionally, in order to increase reactivity of a carbon material, step (i) may be performed by treatment of acid, microwave, or plasma, as described above. The condition of the ball milling, the ultrasonic dispersion treatment in a liquid, arc discharge, and the feature of the carbon material are the same as those described above.

In accordance with yet another aspect of the present invention, there is provided an aluminum-carbon material composite fabricated according to the above method.

In accordance with still yet another aspect of the present invention, there is provided a method for covalent bond formation between aluminum and a carbon material, the method including the steps of: (i) providing an electrochemical apparatus including an anode and a cathode with a carbon material connected thereto; (ii) filling the electrochemical apparatus with an electrolyte containing an organic solvent, a solubilizing agent, a reductant, and an aluminum compound; and (iii) plating a surface of the carbon material connected to the cathode with aluminum by applying a potential to the electrochemical apparatus.

Preferably, an electrochemical cell may be used as the electrochemical apparatus.

In step (i), at least one or two kinds of materials selected from the group consisting of graphite, a graphite fiber, a carbon fiber, a carbon nanofiber, and a carbon nanotube may be used as the carbon material.

It is known that a carbon material available at present has a diameter of 0.4 nm to 16 μm and a length of 10 nm to 10 cm. That is, according to the data reported so far (Science 292, 2462 (2001)), a carbon nanotube is known to have a minimum diameter of 0.4 nm, and a commercialized carbon fiber is known to have a maximum diameter of 16 μm (Taiwan Carbon Technology Co). In examples of the present invention, a multi-walled carbon nanotube with a diameter of 10 to 20 nm and a length of 10 to 20 μm, and an NK carbon nanotube with a diameter of 40 to 60 nm and a length of about 20 μm, were used as a carbon material respectively. A carbon fiber (Toray) with a diameter of 7 to 8 μm and a length of 5 mm was also used. However, in the method of the present invention, no limitation is imposed on the size of a carbon material.

The organic solvent used in step (ii) may include any one kind of solvent or a mixture of at least two kinds of solvents selected from the group consisting of nonprotonic ethers, such as tetrahydrofurane (THF), dimethyl ether, diethyl ether, t-butyl ether, iso-amyl ether, phenyl ether, and methyl-t-butyl ether, and ionic liquids, such as ethylpyridinium halide, N-(1-butyl)pyridinium halide, 1-methyl-3-ethylimidazolium halide, and trimethylphenylammonium halide. However, the organic solvent is not limited thereto. An organic solvent for preparing the electrolyte must satisfy some conditions. First, the organic solvent must be durable enough not to decompose at a potential lower than −1.67V (vs. SHE), which is a potential where aluminum is reduced. Second, the organic solvent must be a polar solvent capable of easily dissolving the aluminum compound so as to provide a high-concentration aluminum solution. Third, the organic solvent must be a Lewis base which can form a coordinate bond with an aluminum ion by reacting with a Lewis acid.

The solubilizing agent used for providing a high-concentration electrolyte in step (ii) may include, but may not be limited to, any one kind of material or a mixture of at least two kinds of materials selected from the group consisting of aromatic hydrocarbons, such as benzene, phenol, toluene, xylene, and mesitylene.

The reductant used for accelerating precipitation of aluminum in step (ii) may include, but may not be limited to, any one material selected from the group consisting of lithium aluminum hydride (LiAlH₄), lithium hydride (LiH), sodium borohydride (NaBH₄), and lithium chloride (LiCl).

The aluminum compound used for aluminum plating in step (ii) may include, but may not be limited to, any one selected from the group consisting of aluminum halides (AlXx) and organoaluminum compounds.

The potential applied to the electrochemical apparatus in step (iii) may be equal to or less than a potential where aluminum is reduced. Therefore, the potential may vary with an organic solvent to be used. For example, when THF belonging to nonprotonic ethers is used as the organic solvent, a potential, ranging from −5 V to −1.67 V (vs. SHE) where aluminum is reduced, may be applied. Also, when ethylpyridinium halide belonging to ionic liquids is used as the organic solvent, a potential of −10 V to −1.67 V (vs. SHE) may be applied.

In accordance with still yet another aspect of the present invention, there is provided a method of fabricating an aluminum-carbon material composite, the method comprising the steps of: (i) providing an electrochemical apparatus including an anode and a cathode with a carbon material connected thereto; (ii) filling the electrochemical apparatus with an electrolyte containing an organic solvent, a solubilizing agent, a reductant, and an aluminum compound; and (iii) plating a surface of the carbon material connected to the cathode with aluminum by applying a potential to the electrochemical apparatus so as to form a covalent bond between the aluminum and the carbon material.

The organic solvent, the solubilizing agent, the reductant, and the aluminum compound in step (ii), and the condition of the applied potential and the feature of the carbon material in step (iii)_are the same as those described above.

In accordance with still yet another aspect of the present invention, there is provided an aluminum-carbon material composite fabricated according to the above method.

In the present invention, the existing problem of bonding between aluminum and a carbon material is solved using an electric arc or an electrochemical technique. The electric arc induces an Al—C covalent bond by generating electric arc or Jule heat within a test material when electrons flow between a carbon material and aluminum. The electrochemical technique allows carbon included in a carbon material to form an Al—C covalent bond by reacting with aluminum that is reduced by a potential difference. An aluminum/carbon material composite prepared according to the present invention is light in weight, excellent in mechanical strength, applicable to vehicle parts and aluminum wheels in use.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating a process of forming an Al—C covalent bond between aluminum and a carbon material by using an electric arc according to a preferred embodiment of the present invention;

FIG. 2 is a view illustrating optical photographs taken before and after an Al—C covalent bond between aluminum and a carbon material is induced using an electric arc according to a preferred embodiment of the present invention;

FIG. 3 is a view illustrating results of electron microscopic analyses conducted before and after an Al—C covalent bond between aluminum and a carbon material is induced using an electric arc according to a preferred embodiment of the present invention;

FIG. 4 is a view illustrating results of electron microscopic analyses for sample cross sections, conducted after an Al—C covalent bond between aluminum and a carbon material is induced using an electric arc according to a preferred embodiment of the present invention;

FIG. 5 is a graph illustrating results of Raman analyses conducted after an Al—C covalent bond between aluminum and a carbon material is induced using an electric arc according to a preferred embodiment of the present invention;

FIG. 6 is a graph illustrating results of X-ray diffraction analyses conducted before and after an Al—C covalent bond between aluminum and a carbon material is induced using an electric arc according to a preferred embodiment of the present invention;

FIG. 7 is a graph illustrating results of hardness analyses conducted after an Al—C covalent bond between aluminum and a carbon material is induced using an electric arc according to a preferred embodiment of the present invention;

FIG. 8 is a view schematically illustrating an apparatus for forming an Al—C covalent bond between aluminum and a carbon material by using an electrochemical technique according to a preferred embodiment of the present invention;

FIG. 9 is a flowchart illustrating a process of forming an Al—C covalent bond between aluminum and a carbon material by using an electrochemical technique;

FIG. 10 is a view illustrating electron microscopic photographs taken before and after an Al—C covalent bond between aluminum and a carbon material is induced using an electrochemical technique according to a preferred embodiment of the present invention;

FIG. 11 is a view illustrating results of EDS mapping analyses conducted after an Al—C covalent bond between aluminum and a carbon material is induced using an electrochemical technique according to a preferred embodiment of the present invention;

FIG. 12 is a graph illustrating results of Raman analyses conducted before and after an Al—C covalent bond between aluminum and a carbon material is induced using an electrochemical technique according to a preferred embodiment of the present invention;

FIG. 13 is a graph illustrating results of XPS analyses for aluminum 2 p, conducted after an Al—C covalent bond between aluminum and a carbon material is induced using an electrochemical technique according to a preferred embodiment of the present invention; and

FIG. 14 is a graph illustrating results of X-ray diffraction analyses conducted after an Al—C covalent bond between aluminum and a carbon material is induced using an electrochemical technique according to a preferred embodiment of the present invention.

### DETAILED DESCRIPTION

The present invention provides a method for covalent bond formation between aluminum and a carbon material, the method including the steps of: (i) introducing defects in a carbon material to thereby functionalize the carbon material; (ii) mixing the functionalized carbon material with aluminum to thereby obtain a mixture; and (iii) inducing an Al—C covalent bond by applying an electric arc to the mixture.

Also, the present invention provides a method for covalent bond formation between aluminum and a carbon material, the method including the steps of: (i) providing an electrochemical apparatus including an anode and a cathode with a carbon material connected thereto; (ii) filling the electrochemical apparatus with an electrolyte containing an organic solvent, a solubilizing agent, a reductant, and an aluminum compound; and (iii) plating a surface of the carbon material connected to the cathode with aluminum by applying a potential to the electrochemical apparatus.

Hereinafter, preferred embodiments of the present invention will be described in conjunction with constituent elements and technical features of present invention. However, the following examples are illustrative merely, and the scope of the present invention should not be construed as being limited thereto. Also, the contents of documents cited herein are hereby incorporated by reference.

### EXAMPLES

### Example 1

### Process of Inducing Al—C Covalent Bond Between Aluminum and Carbon Material by Using Electric Arc

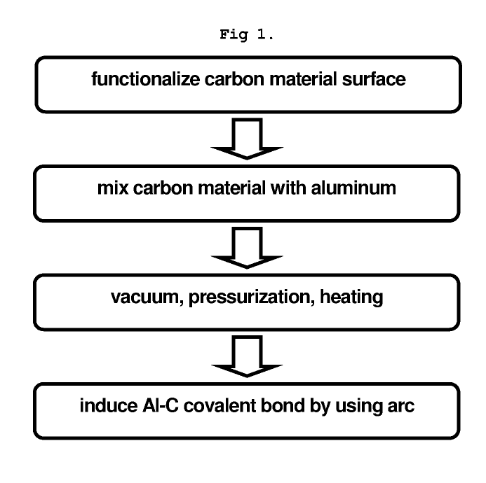

Particulars of the present invention follow an experimental process in FIG. 1. In a series of such experimental processes, a multi-walled carbon nanotube (ILJIN Nanotech, CM95), an NK carbon nanotube (Nano-Karbon, hellow CNT 75), and a carbon fiber (Toray—Japan, T 300) were used as a carbon material. With regard to this, the multi-walled carbon nanotube had a diameter of 10 to 20 nm and a length of to 20 μm, and the NK carbon nanotube had a diameter of 40 to 60 nm and a length of about 20 μm.

1-1-1. Acid Treatment for Inducing Carbon Material to be Functionalized

The carbon nanotube was functionalized by being subjected to an ultrasonic reaction in 70% nitric acid (HNO₃) contained in a water tank-type sonicator for 10 minutes to 3 hours. The NK carbon nanotube was purchased as a functionalized product. The carbon fiber was functionalized by being subjected to an ultra-sonication in a 1:1 mixture of sulfuric acid (H₂SO₄) and nitric acid (HNO₃) for 2 hours.

1-1-2. Microwave Treatment for Inducing Carbon Material to be Functionalized

A carbon material was functionalized through a microwave treatment in such a manner that ethylene glycol or nitric acid (HNO₃) was used as a solvent, sodium chlorate (NaClO₃) was used as a oxidation agent, and the multi-walled carbon nanotube was dispersed in the solvent. The microwave treatment was carried out in a microwave oven (KR-U20AB, Daewoo Electronics, Korea) for 3 minutes. It was possible to set a treatment time within a range of 1 to 6 minutes.

1-1-3. Plasma Treatment for Inducing Carbon Material to be Functionalized

A plasma treatment for the multi-walled carbon nanotube was carried out under atmospheric pressure by using a power consumption of 500 W, and using 500 sccm of oxygen and 300 sccm of helium as a gaseous material. The multi-walled carbon nanotube was treated with plasma for 5 minutes by using an A-tech system product to thereby introduce defects in the carbon nanotube and functionalize the carbon material.

1-2. Inducing Al—C Covalent Bond by Using Electric Arc

19 g of aluminum powder was used as an aluminum product, and 1 g of multi-walled carbon nanotube, NK carbon nanotube, or carbon fiber was used as a carbon material. Each of the functionalized carbon material was mixed with the aluminum powder by using a ball mill. To prevent oxidation of aluminum, the jar was filled with argon gas. After the jar, from which oxygen and moisture were sufficiently removed, was securely sealed, a ball mill process could be carried out at 50 to 400 rpm. It was possible to set a ball mill time within a range of 1 to 24 hours.

3.8 g of each collected carbon material mixed into aluminum was poured into a graphite mold with a diameter of 2 cm to thereby prepare a sample for each carbon material, and a vacuum atmosphere of 10⁻² to 10⁻⁶ torr was formed. Also, each sample was pressurized with a pressure of 30 to 2000 MPa, and then temperature is elevated. The elevated temperature could range from room temperature to 1000° C. Next, an Al—C covalent bond between the carbon material and aluminum was induced by applying a pulse current to induce arc discharge.

### Example 2

### Sample Observation After Inducing Al—C Covalent Bond Between Aluminum and Carbon Material by Using Electric Arc

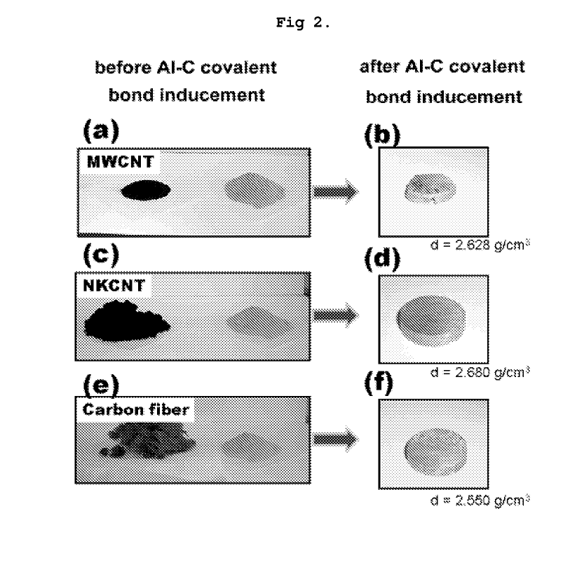

FIG. 2 illustrates photographs of samples, which were taken by a digital camera (koolpix-3700, Nikon) before and after an Al—C covalent bond between aluminum and each carbon material was induced using an electric arc.

FIG. 2(a) is a photograph taken before a multi-walled carbon nanotube (MWCNT) was not mixed with aluminum, and FIG. 2(b) is a photograph taken after the MWCNT and aluminum samples in FIG. 2(a) were mixed, and then were induced to bond with each other by using an electric arc. As a result of observing the photographs, the MWCNT was not externally visible, and thus it could be noted that the MWCNT did not fall out of an aluminum matrix. Measured apparent density was 2.63 g/cm³, which was lower than that of common aluminum, and thus it could be expected that the MWCNT was included within the aluminum matrix.

FIG. 2(c) is a photograph taken before an NK carbon nanotube (NKCNT) was mixed with aluminum. The NKCNT had a diameter greater than that of a common multi-walled carbon nanotube, and thus it could be observed that the apparent volume of the NKCNT was greater than that of aluminum. Also, FIG. 2(d) is a photograph taken after the NKCNT and aluminum samples in FIG. 2(c) were mixed, and then were induced to bond with each other by using an electric arc. Similar to the result of observing the photographs in FIGS. 2(a) and 2(b), it could be noted that the NKCNT did not fall out of an aluminum matrix. Measured apparent density was 2.68 g/cm³, which meant that the same result as in FIGS. 2(a) and 2(b) was obtained.

FIG. 2(e) is a photograph taken before a carbon fiber was mixed with aluminum. It could be observed that the carbon fiber had apparent volume greater than that of aluminum. Also, FIG. 2(f) is a photograph taken after an electric arc was generated for the carbon fiber and aluminum samples in FIG. 2(e). Similar to other carbon materials, it could be noted that the carbon fiber was not externally revealed. Measured apparent density was 2.55 g/cm³, which also meant that the same result as in FIGS. 2(a) and 2(b) was obtained, and thus it could be noted that the carbon fiber was included within aluminum.

### Example 3

### Electron Microscopic Analysis of Sample Surface After Inducing Al—C Covalent Bond Between Aluminum and Carbon Material by Using Electric Arc

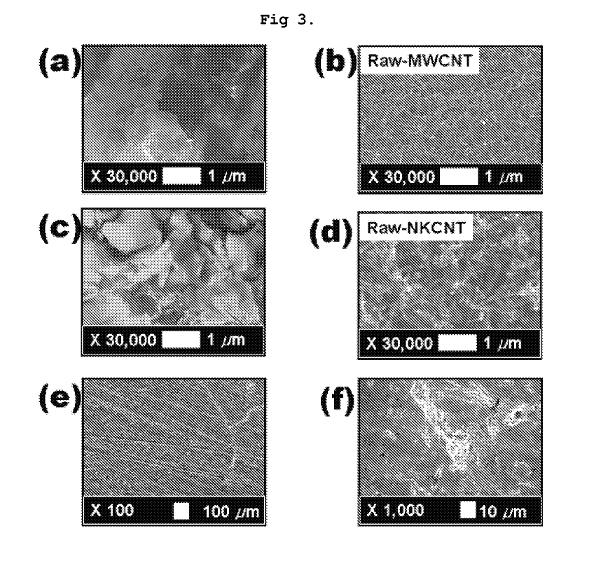

FIG. 3 illustrates photographic analysis data of sample surfaces, measured by an electron microscope (JSM7000F, JEOL) after an Al—C covalent bond between aluminum and a carbon material was induced using an electric arc.

FIG. 3(a) is an electron microscopic photograph of a sample surface, taken after an Al—C covalent bond between aluminum and a multi-walled carbon nanotube was induced, and FIG. 3(b) is an electron microscopic photograph of the multi-walled carbon nanotube before the experiment. Comparing these two photographs in consideration of the same magnification thereof, it could be noted that the multi-walled carbon nanotube was not externally revealed.

FIGS. 3(c) and 3(d) are electron microscopic photographs taken before and after an Al—C covalent bond between aluminum and an NK carbon nanotube was induced. Comparing these two photographs in consideration of the same magnification thereof, as in the experiment for the multi-walled carbon nanotube, it could be noted that the NK carbon nanotube was not externally revealed.

FIGS. 3(e) and 3(f) are electron microscopic photographs taken after an Al—C covalent bond between aluminum and a carbon fiber was induced. The photograph of FIG. 3(e) was taken with a magnification of 100×, and the photograph of FIG. 3(f) was taken with a magnification of 1,000×. The diameter of the carbon fiber was 7 to 8 μm, corresponding to a size observable in an optical photograph. Thus, the carbon fiber might be observed in a photograph with a magnification of 100×. However, as a result of observing FIGS. 3(e) and 3(f), no carbon fiber was externally observed in an Al—C covalent bond-induced sample according to the method of the present invention. Therefore, it could be noted that the carbon fiber did not fallout of an aluminum matrix.

### Example 4

### Analysis of Sample Cross Section After Inducing Al—C Covalent Bond Between Aluminum and Multi-Walled Carbon Nanotube

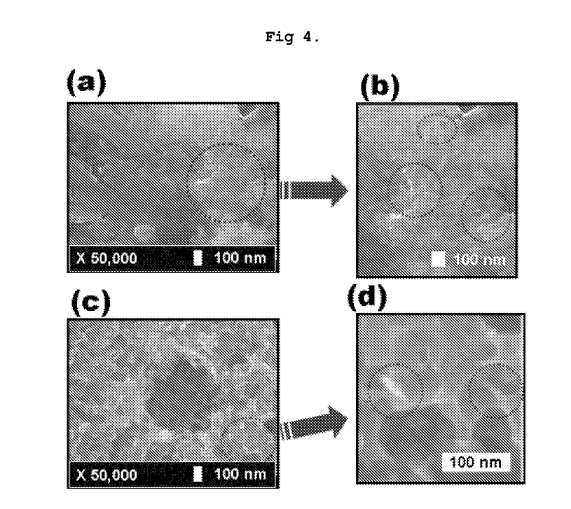

FIGS. 4(a) and 4(b) are photographs of sample cross sections, taken by an electron microscope (JSM7000F, JEOL) after an Al—C covalent bond between aluminum and a multi-walled carbon nanotube was induced. In this example, electron microscopic analysis was conducted for the cross section of a sample so as to photographically verify the actual existence of a carbon nanotube. As a result of the analysis, it could be noted from FIG. 4(b) that the multi-walled carbon nanotube existed within the sample.

FIGS. 4(c) and 4(d) are photographs taken after aluminum was etched with hydrochloric acid so as to specifically verify the existence of the multi-walled carbon nanotube. As a result of this, a part of the multi-walled carbon nanotube was detected in an aluminum surface portion etched with hydrochloric acid.

### Example 5

### Raman Analysis for Verifying Crystallinity of Carbon Material That Forms Covalent Bond With Aluminum by Electric Arc

In order to verify the crystallinity of a carbon material that forms a covalent bond with an aluminum matrix, the crystallinity was measured by Raman spectrometry. Raman spectrometry equipment was Invia Basic model equipment of Reinshaw, using a 633 nm He/Ne laser.

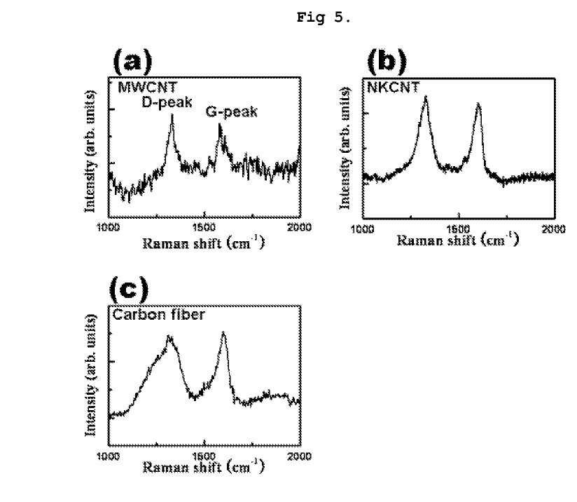

FIGS. 5(a), 5(b) and 5(c) are Raman analysis data of surfaces of aluminum samples, each of which bonded with a multi-walled carbon nanotube, an NK carbon nanotube, and a carbon fiber. A G-peak vibration mode corresponding to crystal vibration of the carbon sp² hybridized bond of a carbon material could be detected in the Raman analysis data of all the samples. The sp² hybridized bond is a structure indicative of the crystallinity of graphite, and the main framework of a carbon nanotube, a carbon material, and the like is formed by the sp² hybridized bond. From this result, it could be noted that the crystallinity of a covalent bonded carbon material within an aluminum sample was not destroyed and was maintained intact in the course of electric arc micro bonding.

### Example 6

### X-ray Diffraction Analysis of Aluminum/Carbon Material That Forms Covalent Bond by Electric Arc

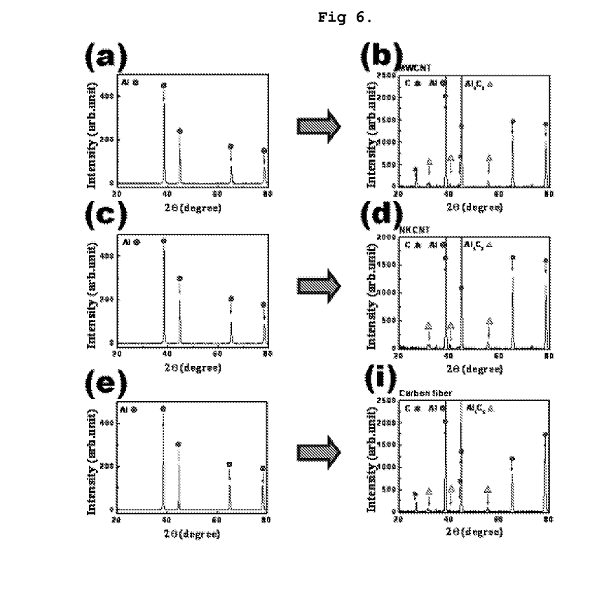

X-ray diffraction analysis data was used for verifying covalent bond formation between aluminum and a carbon material. An X-ray diffraction analyzer is equipment of model no. D8 FOCUS (2.2 KW) of BRUKER AXS, Germany, using a Cu Kα 1.54 Å. FIG. 6 illustrates X-ray diffraction analysis data measured before and after an Al—C covalent bond between aluminum and a carbon material was induced.

FIG. 6(a) is X-ray diffraction analysis data measured after a multi-walled carbon nanotube was mixed with aluminum. A peak for an aluminum crystal could be detected in the X-ray diffraction analysis data. FIG. 6(b) is X-ray diffraction analysis data measured after electric arc bonding was conducted for the sample of FIG. 6(a). In this data, diffraction peaks of aluminum carbide (Al₄C₃) could be detected at angles of 31.11° (double), 40.0° and 55.0°. From this result, it could be noted that a covalent bond between the multi-walled carbon nanotube and aluminum was formed in the sample.

FIGS. 6(c) and 6(d) are X-ray diffraction analysis data measured before and after electric arc bonding was conducted between aluminum and an NK carbon nanotube. In a similar manner to the multi-walled carbon nanotube, X-ray diffraction peaks of aluminum carbide were detected after the electric arc bonding, in the case of the NK carbon nanotube. By this, it could be noted that a covalent bond between aluminum and carbon was also formed in the NK carbon nanotube.

FIGS. 6(e) and 6(f) are X-ray diffraction analysis data for a carbon fiber. In this data, it could be noted that the above-mentioned result was also obtained in the carbon fiber.

### Example 7

### Hardness Analysis of Sample with Covalent Bond Formation Between Aluminum and Carbon Material by use of Electric Arc

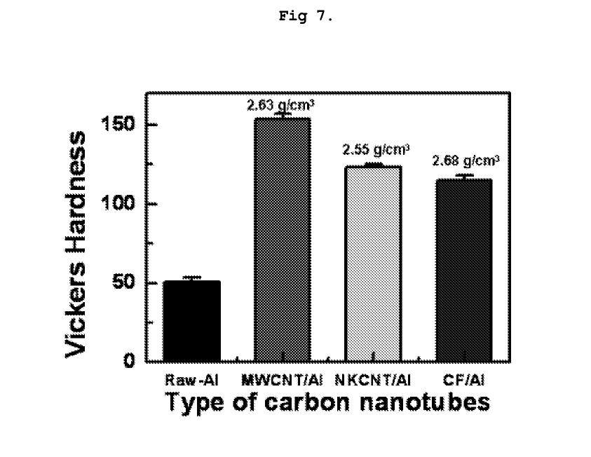

In this example, the effect of a covalent bonded carbon material within aluminum on mechanical hardness was measured. FIG. 7 illustrates data indicating hardness values of aluminum samples containing a carbon material. For each sample, hardness was measured five times at different locations by using a Vickers hardness testing machine (MVK-H2, AKASHI, Japan). An average of the measured hardness values for each sample, together with a tolerance range, was represented by a histogram. A multi-walled carbon nanotube showed the highest hardness. In the present invention, when the multi-walled carbon nanotube was added to aluminum, hardness was trebled or more as compared to commonly used aluminum (A356-T6). Next, hardness was higher in order of an NK carbon nanotube and a carbon fiber. The multi-walled carbon nanotube has a tensile strength of 63 GPa (Reference: http://en.wikipedia.org/wiki/Carbon_nanotube), and the carbon fiber has a tensile strength of 3.5 GPa (Reference: Toray Industries). When considering that the NK carbon nanotube has greater diameter and more defects than those of the multi-walled carbon nanotube, it is expected to have smaller tensile strength. The experimental values measured in this example coincided with the above data. Therefore, it could be noted that the carbon material formed a covalent bond with aluminum within an aluminum matrix, and had a great effect on strength.

### Example 8

### Process of Inducing Al—C Covalent Bond by using Electrochemical Technique

In this example, there is provided a method of forming a covalent bond between aluminum and a carbon material by using an electrochemical technique.

8-1. Preparation of Electrolyte

THF was used as an organic solvent for preparing an electrolyte, and benzene was added so as to provide a high-concentration electrolyte. Also, in order to enhance the activity of an electrolyte, lithium aluminum hydride (LiAlH₄) was added. Aluminum chloride (AlCl₃) with high purity and without moisture was used as an aluminum compound. All operations for preparing an electrolyte were performed in a glove box which was free from moisture and was filled with argon gas.

8-2. Process of Forming Al—C Covalent Bond by Using Electrochemical Technique

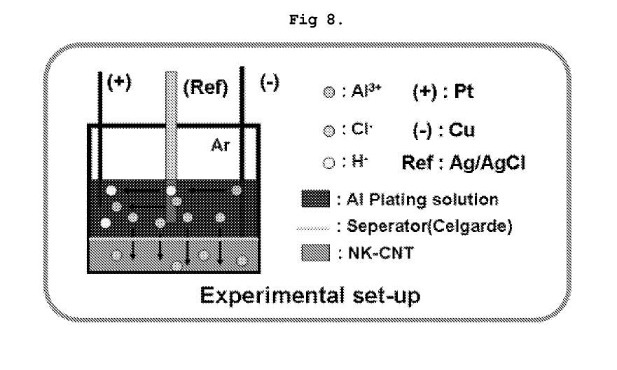

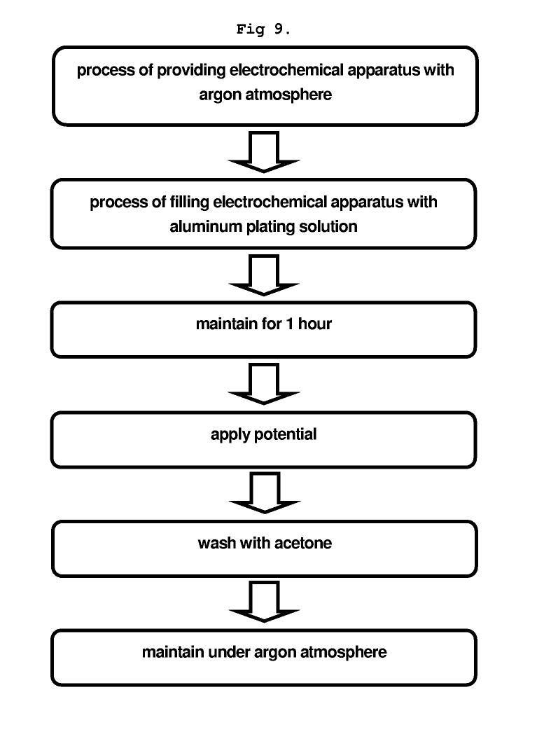

FIG. 8 schematically illustrates an electrochemical apparatus for performing an electrochemical technique according to the present invention, and FIG. 9 illustrates the overall procedure of the electrochemical technique. Reference will now be made to the electrochemical technique according to the present invention, with reference to FIGS. 8 and 9.

The electrochemical apparatus used a vial with a size of 15 ml. First of all, a copper film was used as an electron collector capable of providing a carbon nanotube with a potential. The copper film was washed with acid to thereby remove an oxide layer from the surface of the copper film. The pickled copper film was cleanly washed with distilled water again, and then was subjected to moisture removal with acetone. As seen from FIG. 8, the pickled copper film was laid in a lower portion of the 15 ml vial.

Next, NK carbon nanotube was placed on the copper film. In order to improve the conductivity of the NK carbon nanotube, and thus allow the NK carbon nanotube to fill the role thereof, that is, to efficiently transfer electrons to aluminum ions, the NK carbon nanotube was subjected to a heat treatment at a temperature of 1000° C. under an argon atmosphere for 1 hour.

The electrochemical apparatus was covered by an ion exchange membrane so that the NK carbon nanotube improved in conductivity through the above process does not touch a counter electrode.

An electrically and chemically stable platinum network was used as the counter electrode. The platinum network was inserted into the vial to the extent that it did not reach the ion exchange membrane, and then the vial was sealed. An aperture with a size of about 0.5 mm was punctured in the sealed vial, and the vial was vacuumized in a vacuum chamber. The vial was left in vacuum to thereby completely remove moisture within the NK carbon nanotube and the electrochemical apparatus, and then the vial was filled with argon.

A reference electrode was washed, and then was brought in the electrochemical apparatus. After all the operations were completed, the electrolyte was injected into the electrochemical apparatus. An Al—C covalent bond between aluminum and the carbon material was induced by applying a potential ranging from −5V where THF would not decompose and −1.67V (vs. SHE) where aluminum might be reduced. After a time of 20 minutes elapsed, it could be verified that the carbon nanotube was covered by aluminum, as a result of electro microscopy.

### Example 9

### Electron Microscopic Analysis After Inducing Al—C Covalent Bond Between Aluminum and Carbon Material by Using Electrochemical Technique

In this example, observations using an electron microscope (JSM7000F, JEOL) were carried out before and after an Al—C covalent bond between aluminum and a carbon material was induced using an electrochemical technique.

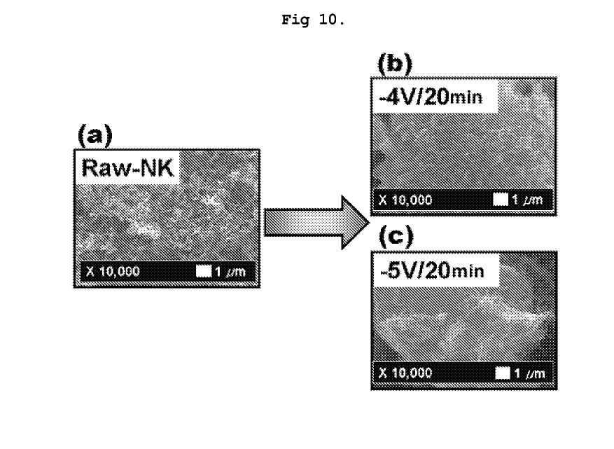

FIG. 10 illustrates electron microscopic photographs taken before and after an Al—C covalent bond between aluminum and an NK carbon nanotube was induced. FIG. 10(a) is an electron microscopic photograph taken before an Al—C covalent bond of the NK carbon nanotube was induced, and FIGS. 10(b) and 10(c) are electron microscopic photographs, each taken after an Al—C covalent bond was induced at −4V and −5V vs. Ag/AgCl Ref. Comparing the photograph of FIG. 10(a) taken before Al—C covalent bond inducement with the photographs of FIGS. 10(b) and 10(c) taken after Al—C covalent bond inducement, it could be noted that a translucent object believed to be aluminum was covered over the surface of the NK carbon nanotube.

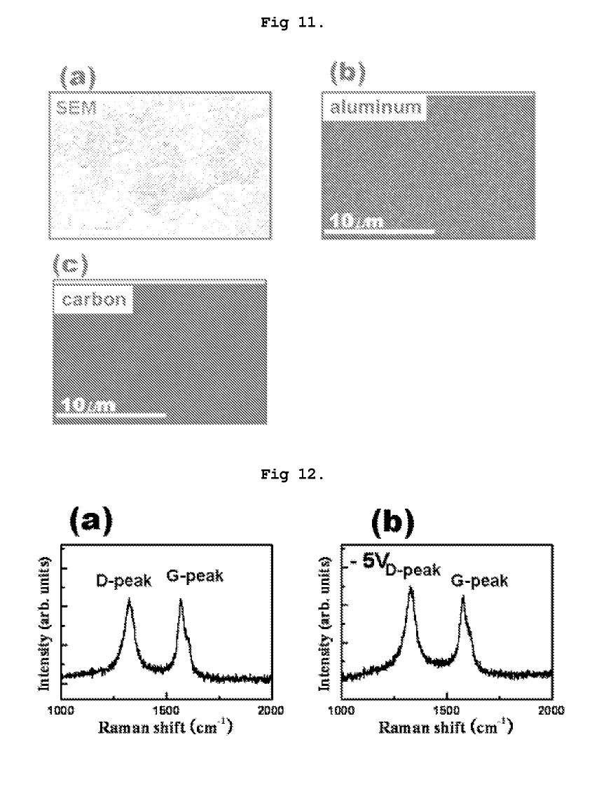

FIG. 11 illustrates EDS (Energy Dispersive X-ray Spectroscopy) mapping analysis data measured after an Al—C covalent bond was induced by an electrochemical reaction at −3V. The EDS was carried out using an appendage to an electron microscope (model no. JSM7000F, JEOL, Japan), and as a result of the EDS, aluminum was identified. Therefore, it could be noted that the above object covering the NK carbon nanotube in FIGS. 10(b) and 10(c) was aluminum.

### Example 10

### Raman Analysis for Verifying Crystallinity of Carbon Material That Forms Covalent Bond With Aluminum by Electrochemical Technique

In this example, Raman spectrometry analysis was carried out to verify crystallinity after an Al—C covalent bond of a carbon nanotube was induced using electrochemical technique. Raman spectrometry equipment was Invia Basic model equipment of Reinshaw, using a 633 nm He/Ne laser. FIGS. 12(a) and 12(b) are Raman analysis data before and after Al—C covalent bond inducement. Even after Al—C covalent bond formation, a G-peak vibration mode corresponding to crystal vibration of the carbon sp² hybridized bond of a carbon material could be detected in the Raman analysis data. Therefore, it could be noted that the crystallinity of the carbon nanotube was maintained intact even after Al—C covalent bond formation.

### Example 11

### XPS Analysis of Aluminum/Carbon Material That Forms Covalent Bond by Electrochemical Technique

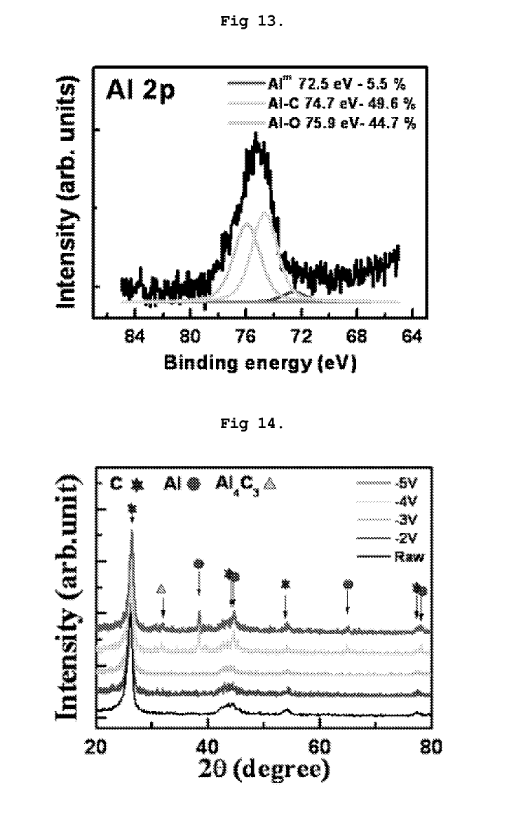

In this example, an Al—C covalent bond between aluminum and a carbon nanotube was analyzed using chemical bond analysis equipment XPS (X-ray Photoelectron Spectroscopy) (ESCA2000, VG-microtech). FIG. 13 illustrates XPS analysis data of aluminum 2p. When considering that the XPS measures regions located within several nanometers from a surface, it can analyze a surface oxide layer and an internal Al—C covalent bond layer of aluminum. From this result, it could be noted that an Al—C covalent bond between aluminum and the carbon nanotube was actually formed.

### Example 12

### X-ray Diffraction Analysis of Aluminum/Carbon Material That Forms Covalent Bond by Electrochemical Technique

FIG. 14 illustrates X-ray diffraction analysis data measured after an electrochemical reaction was carried out according to potentials. In the graph of FIG. 10, data for a carbon nanotube without any electrochemical reaction is presented in the lowest portion, and data according to various potentials are presented in order of −2V to −5V, from the bottom to the top. Starting from a potential of −4V, peaks of aluminum metal crystals appeared at angles of 38.5°, 44.7°, 65.1° and 78.2°. In addition, an X-ray diffraction peak was detected at an angle of about 31°, which was a peak of aluminum carbide indicative of an Al—C covalent bond. From this result, it could be noted that a covalent bond between aluminum and carbon was formed using the electrochemical technique.

A carbon material/aluminum composite prepared according to the present invention is light in weight, excellent in mechanical strength, and applicable to vehicle parts and aluminum wheels in use. Also, the carbon material/aluminum composite of the present invention is expected to extend the aluminum wheel market to commercial vehicles and large-sized trucks beyond automobiles. Moreover, it is expected that the inventive composite can be utilized as materials of aircrafts, spacecrafts, ships, etc., requiring high strength. Finally, the inventive composite is expected to be applicable to computer parts, various cooler parts, and the like due to its high thermal conductivity.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A method for covalent bond formation between aluminum and a carbon material, the method comprising the steps of:
(i) introducing defects in a carbon material to thereby functionalize the carbon material;
(ii) mixing the functionalized carbon material with aluminum to thereby obtain a mixture; and
(iii) inducing an Al—C covalent bond by applying an electric arc to the mixture.

2. The method as claimed in claim 1, wherein step (i) is performed by an ultrasonic reaction in nitric acid (HNO₃), sulfuric acid (H₂SO₄), or a 1:1 mixture of nitric acid and sulfuric acid.

3. The method as claimed in claim 1, wherein step (i) is performed by dispersing the carbon material to one or at least two kinds of mixtures selected from a group including ethylene glycol, nitric acid (HNO₃) and sulfuric acid (H₂SO₄); and carrying out microwave treatment for 1 to 10 minutes.

4. The method as claimed in claim 1, wherein step (i) is performed by carrying out plasma treatment on the carbon material for 1 minute to 1 hour, the plasma formed by using one or at least two kinds of mixture gases selected from a group including oxygen, argon, and helium, and using electric power of 50 to 1000 W.

5. The method as claimed in claim 1, wherein step (ii) comprises the step of carrying out a ball mill treatment or an ultrasonic dispersion treatment in a liquid phase to mix the carbon material with the aluminum.

6. The method as claimed in claim 1, wherein step (iii) is performed by applying a pulse current to the mixture of the carbon material and aluminum.

7. The method as claimed in any one of claims 1 to 6, wherein the carbon material comprises at least one or two kinds of materials selected from the group consisting of graphite, a graphite fiber, a carbon fiber, a carbon nanofiber, and a carbon nanotube.

8. The method as claimed in any one of claims 1 to 6, wherein the carbon material has a diameter of 0.4 nm to 16 μm and a length of 10 nm to 10 cm.

9. A method of fabricating an aluminum-carbon material composite, the method comprising the steps of:
(i) introducing defects in a carbon material to thereby functionalize the carbon material;
(ii) mixing the functionalized carbon material with aluminum to thereby obtain a mixture; and
(iii) inducing an Al—C covalent bond by applying an electric arc to the mixture.

10. The method as claimed in claim 9, wherein step (i) is performed by an ultrasonic reaction in nitric acid (HNO₃), sulfuric acid (H₂SO₄), or a 1:1 mixture of nitric acid and sulfuric acid.

11. The method as claimed in claim 9, wherein step (i) is performed by dispersing the carbon material to one or at least two kinds of mixtures selected from a group including ethylene glycol, nitric acid (HNO₃) and sulfuric acid (H₂SO₄); and carrying out microwave treatment for 1 to 10 minutes.

12. The method as claimed in claim 9, wherein step (i) is performed by carrying out plasma treatment on the carbon material for 1 minute to 1 hour, the plasma formed by using one or at least two kinds of mixture gases selected from a group including oxygen, argon, and helium, and using electric power of 50 to 1000 W.

13. The method as claimed in claim 19 wherein step (ii) comprises the step of carrying out a ball mill treatment or an ultrasonic dispersion treatment in a liquid phase to mix the carbon material with the aluminum.

14. The method as claimed in claim 9, wherein step (iii) is performed by applying a pulse current to the mixture of the carbon material and aluminum.

15. The method as claimed in any one of claims 9 to 14, wherein the carbon material comprises at least one or two kinds of materials selected from the group consisting of graphite, a graphite fiber, a carbon fiber, a carbon nanofiber, and a carbon nanotube.

16. The method as claimed in any one of claims 9 to 14, wherein the carbon material has a diameter of 0.4 nm to 16 μm and a length of 10 nm to 10 cm.

17. An aluminum-carbon material composite fabricated according to a method of any one of claims 9 to 14.

18. The composite as claimed in claim 17, wherein the carbon material is one or at least two kinds of mixtures selected from a group including graphite, a graphite fiber, a carbon fiber, a carbon nanofiber, and a carbon nanotube.

19. The composite as claimed in claim 17, wherein the carbon material has a diameter 0.4 nm to 16 μm, and a length of 10 nm to 10 cm.

20. A method for covalent bond formation between aluminum and a carbon material, the method comprising the steps of:
(i) providing an electrochemical apparatus including an anode and a cathode with a carbon material connected thereto;
(ii) filling the electrochemical apparatus with an electrolyte containing an organic solvent, a solubilizing agent, a reductant, and an aluminum compound; and
(iii) plating a surface of the carbon material connected to the cathode with aluminum by applying a potential to the electrochemical apparatus.

21. The method as claimed in claim 20, wherein in step (ii), the organic solvent comprises any one kind of solvent or a mixture of at least two kinds of solvents selected from the group consisting of tetrahydrofurane (THF), dimethyl ether, diethyl ether, t-butyl ether, iso-amyl ether, phenyl ether, methyl-t-butyl ether, ethylpyridinium halide, N-(1-butyl)pyridinium halide, 1-methyl-3-ethylimidazolium halide, and trimethylphenylammonium halide.

22. The method as claimed in claim 20 wherein in step (ii), the solubilizing agent comprises any one kind of material or a mixture of at least two kinds of materials selected from the group consisting of benzene, phenol, toluene, xylene, and mesitylene.

23. The method as claimed in claim 20, wherein in step (ii), the reductant comprises any one material selected from the group consisting of lithium aluminum hydride (LiAlH₄), lithium hydride (LiH), sodium borohydride (NaBH₄), and lithium chloride (LiCl).

24. The method as claimed in claim 20, wherein in step (ii), the aluminum compound comprises any one selected from the group consisting of aluminum halides (AlXx) and organoaluminum compounds.

25. The method as claimed in claim 20, wherein in step (iii), the potential ranges from a potential where the organic solvent does not decompose to a potential where the aluminum can be reduced

26. The method as claimed in claim 20, wherein in step (iii), the potential ranges from −10 V to −1.67 V.

27. The method as claimed in claim 20, wherein the carbon material comprises at least one or two kinds of materials selected from the group consisting of graphite, a graphite fiber, a carbon fiber, a carbon nanofiber, and a carbon nanotube.

28. The method as claimed in any one of claims 20 to 26, wherein the carbon material has a diameter of 0.4 nm to 16 μm and a length of 10 nm to 10 cm.

29. A method of fabricating an aluminum-carbon material composite, the method comprising the steps of:
(i) providing an electrochemical apparatus including an anode and a cathode with a carbon material connected thereto;
(ii) filling the electrochemical apparatus with an electrolyte containing an organic solvent, a solubilizing agent, a reductant, and an aluminum compound; and
(iii) plating a surface of the carbon material connected to the cathode with aluminum by applying a potential to the electrochemical apparatus so as to form covalent bond between aluminum and the carbon material.

30. The method as claimed in claim 29, wherein in step (ii), the organic solvent comprises any one kind of solvent or a mixture of at least two kinds of solvents selected from the group consisting of tetrahydrofurane (THF), dimethyl ether, diethyl ether, t-butyl ether, iso-amyl ether, phenyl ether, methyl-t-butyl ether, ethylpyridinium halide, N-(1-butyl)pyridinium halide, 1-methyl-3-ethylimidazolium halide, and trimethylphenylammonium halide.

31. The method as claimed in claim 29 wherein in step (ii), the solubilizing agent comprises any one kind of material or a mixture of at least two kinds of materials selected from the group consisting of benzene, phenol, toluene, xylene, and mesitylene.

32. The method as claimed in claim 29, wherein in step (ii), the reductant comprises any one material selected from the group consisting of lithium aluminum hydride (LiAlH₄), lithium hydride (LiH), sodium borohydride (NaBH₄), and lithium chloride (LiCl).

33. The method as claimed in claim 29, wherein in step (ii), the aluminum compound comprises any one selected from the group consisting of aluminum halides (AlXx) and organoaluminum compounds.

34. The method as claimed in claim 29, wherein in step (iii), the potential ranges from a potential where the organic solvent does not decompose to a potential where the aluminum can be reduced

35. The method as claimed in claim 29, wherein in step (iii), the potential ranges from −10 V to −1.67 V.

36. The method as claimed in any one of claims 29 to 35, wherein the carbon material comprises at least one or two kinds of materials selected from the group consisting of graphite, a graphite fiber, a carbon fiber, a carbon nanofiber, and a carbon nanotube.

37. The method as claimed in any one of claims 29 to 35, wherein the carbon material has a diameter of 0.4 nm to 16 μm and a length of 10 nm to 10 cm.

38. An aluminum-carbon material composite fabricated according to a method of any one of claims 29 to 35.

39. The composite as claimed in claim 38, wherein the carbon material is one or at least two kinds of mixtures selected from a group including graphite, a graphite fiber, a carbon fiber, a carbon nano fiber, and a carbon nanotube.

40. The composite as claimed in claim 38, wherein the carbon material has a diameter 0.4 nm to 16 μm, and a length of 10 nm to 10 cm.
